(19) United States
(12) Patent Application Publication
(10) Pub. No.: US 2015/0161626 A1
(43) Pub. Date: Jun. 11, 2015

(54) B2C Platform Implementation Method and System

(71) Applicant: Gainco Technology Limited, Hong Kong (HK)

(72) Inventor: Janson Po Zhou Chu, Hong Kong (HK)

(73) Assignee: Gainco Technology Limited

(21) Appl. No.: 14/561,232

(22) Filed: Dec. 5, 2014

(30) Foreign Application Priority Data
Dec. 10, 2013 (HK) 13113686.7

(51) Int. Cl. G06Q 30/02; G06F 17/30; H04L 29/06

(52) U.S. Cl. CPC G06Q 30/0201; H04L 67/42; G06F 17/30289

(57) ABSTRACT

The present invention discloses a B2C platform implementation method and system, wherein the implementation system comprises: a SQL database, used for storing setup information of applications and CRM/ERP data; a database management system, used for regularly acquiring primary data from the SQL database, and analyzing the acquired data to generate a chart form marketing report; a Web server, used for managing interfaces, user login authority and marketing report classification, and pushing business news and marketing report to a server; an application server, used for providing transmission of instant text information among a plurality of clients, and pushing the business news and marketing report to the plurality of clients; and the plurality of clients equipped with an application, used for business communications and displaying the business news and marketing report.

### CROSS-REFERENCE TO RELATED APPLICATION

This application claims priority of Hong Kong patent application No. 13113686.7 filed on Dec. 10, 2013, the entire content of which is hereby incorporated by reference.

### FIELD OF THE INVENTION

The present invention relates to the field of internet, and in particular, to a B2C platform implementation method and system.

### BACKGROUND

With the rapid popularization of internet, E-commerce has also obtained unprecedented development space therewith. For the existing B2C (Business-to-Customer) trading system, its function is only limited to: provide customers with emporium websites for online shopping; ship the merchandises purchased by the customers; and be responsible for customer identification as well as payment settlement banks and authentication.

### SUMMARY

A technical problem to be solved by the present invention is to provide a B2C platform implementation method and system.

To solve the technical problem, the present invention employs a technical scheme as follows: constructing a B2C platform implementation system, comprising:

a SQL database, used for storing setup information of applications and CRM/ERP data;

a database management system, used for regularly acquiring primary data from the SQL database, and analyzing the acquired data to generate a chart form marketing report;

a Web server, used for managing interfaces, user login authority and marketing report classification, and pushing business news and marketing report to a server;

an application server, used for providing transmission of instant text information among a plurality of clients, and pushing the business news and marketing report to the plurality of clients; and

the plurality of clients equipped with an application, used for business communications and displaying the business news and marketing report.

In the B2C platform implementation system according to the present invention, the application server enables transmission of instant text information among the plurality of clients through a chat room.

In the B2C platform implementation system according to the present invention, the marketing report at least comprises the several types as follows: sales, purchasing, production, account receivable, account payable, ledger, financial report, and human resources.

In the B2C platform implementation system according to the present invention, the application server further pushes calendar/task/news release/position information of other clients to the plurality of clients.

In the B2C platform implementation system according to the present invention, the application server, on the basis of a user subscription request, pushes the marketing report to the plurality of clients in a specific time or in response to a specific event.

The present invention further constructs a B2C platform implementation method, comprising:

user login step: a client sends user login request information to a Web server, and the Web server pushes login verification information to a SQL database according to the user login request information; if the login verification information is verified by the SQL database, then the Web server sends login confirmation information to the client, and the client sends group update information and session information to the Web server; and

report viewing report: the client sends report request information to the Web server, and a database management system processes primary data acquired regularly from the SQL database according to the report request information received by the Web server to generate a marketing report, and pushes the generated marketing report to the Web server; the Web server then pushes the marketing report to an application server, and the application server finally pushes the marketing report to the client.

In the B2C platform implementation method according to the present invention, the method further comprises:

user group creation step: the client sends user group creation request information to the Web server, and the Web server sends user group creation verification information to the SQL database according to the user group creation request information; if the user group creation verification information is verified by the SQL database, then the Web server sends user group creation confirmation information to the client; meanwhile, the Web server broadcasts user group update information to other clients.

In the B2C platform implementation method according to the present invention, the method further comprises:

user group joining step: the client sends user group jointing request information to the Web server, and the Web server sends user group joining verification information to the SQL database according to the user group joining request information; if the user group joining verification information is verified by the SQL database, then the Web server sends user group joining confirmation information to the client; meanwhile, the Web server broadcasts user group update information to other clients.

In the B2C platform implementation method according to the present invention, the method further comprises:

user group ending step: the client sends user group ending request information to the Web server, and the Web server sends user group ending verification information to the SQL database according to the user group ending request information; if the user group ending verification information is verified by the SQL database, then the Web server sends user group ending confirmation information to the client; meanwhile, the Web server broadcasts user group update information to other clients.

In the B2C platform implementation method according to the present invention, the method further comprises:

session text sharing step: the client sends session text information to the Web server, and the Web server sends session text verification information to the SQL database according to the received session text information; if the session text verification information is verified by the SQL database, then the Web server sends session text sending confirmation information to the client; meanwhile, the Web server broadcasts session text sending update information to other clients.

In the B2C platform implementation method according to the present invention, the method further comprises:

news information release step: a Web browser sends news addition information to the Web server, and the Web server sends news verification information to the SQL database according to the received news addition information; if the news addition information is verified by the SQL database, then the Web server broadcasts news update information to other clients.

In the B2C platform implementation method according to the present invention, the method further comprises:

GPS positioning step: the client acquires current position information and sends the position information to the Web server, and the Web server sends position sending verification information to the SQL database according to the received position information; if the position sending verification information is verified by the SQL database, then the Web server sends position sending confirmation information to the client; meanwhile, the Web server broadcasts position sending update information to other clients.

In the B2C platform implementation method according to the present invention, the client transmits the session text information or position information to other clients through GCM.

### BRIEF DESCRIPTION OF THE DRAWINGS

The present invention will be further described hereinafter with reference to the drawings and embodiments, wherein in the drawings:

FIG. 1 is a partial logical diagram of embodiments of a B2C platform implementation system according to the present invention;

FIGS. 2A-2D are schematic diagrams of different types of marketing reports; and

FIGS. 3A-3K are several schematic diagrams of user interfaces in clients.

### DETAILED DESCRIPTION

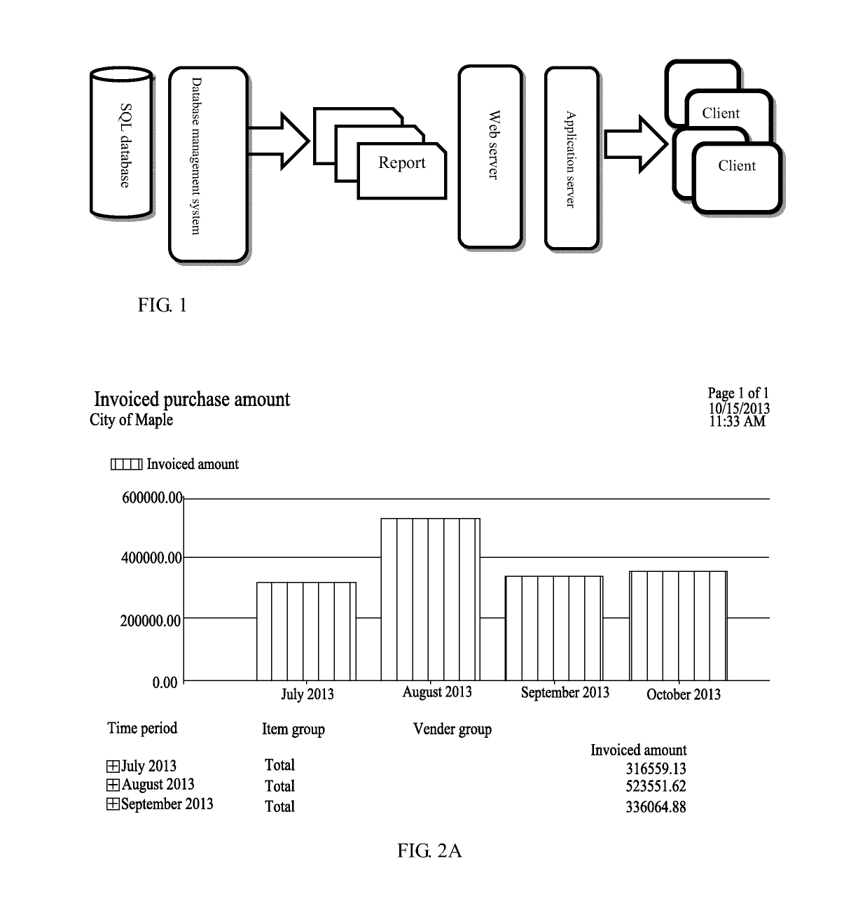

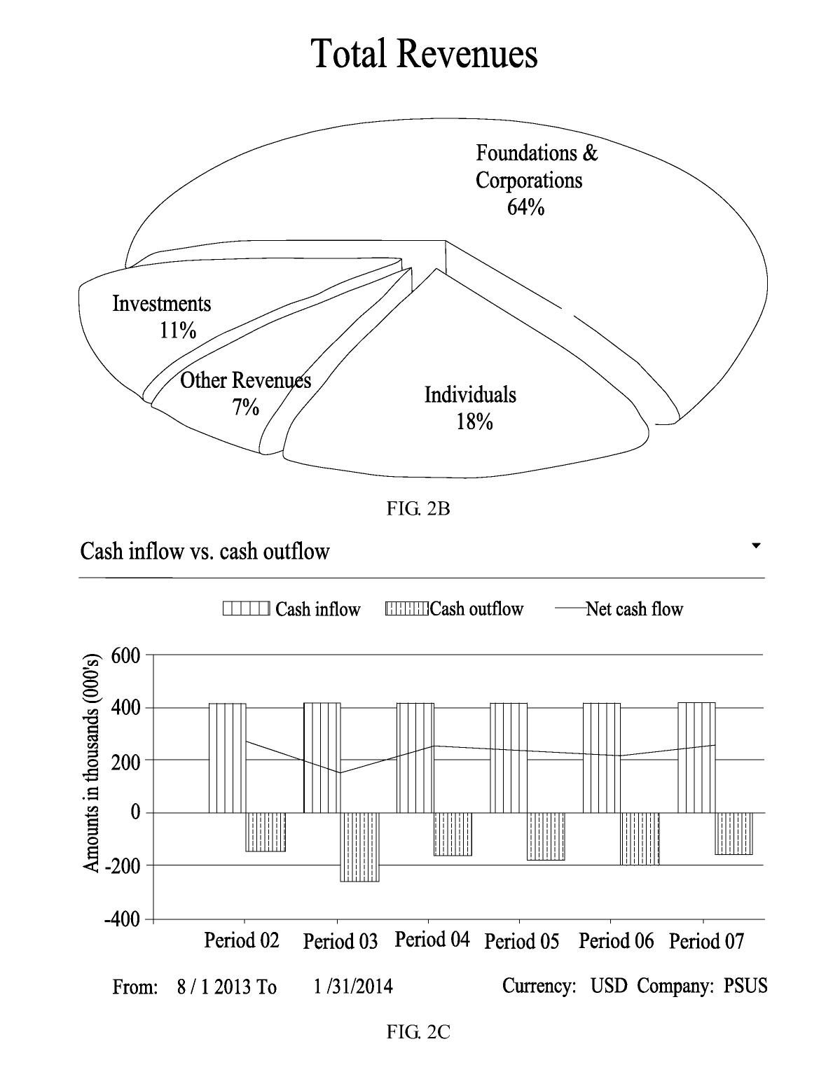

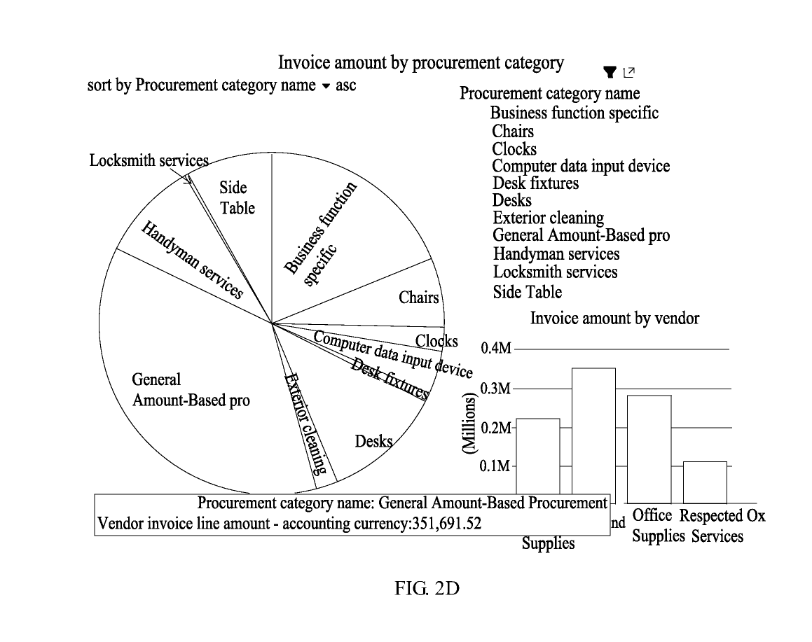

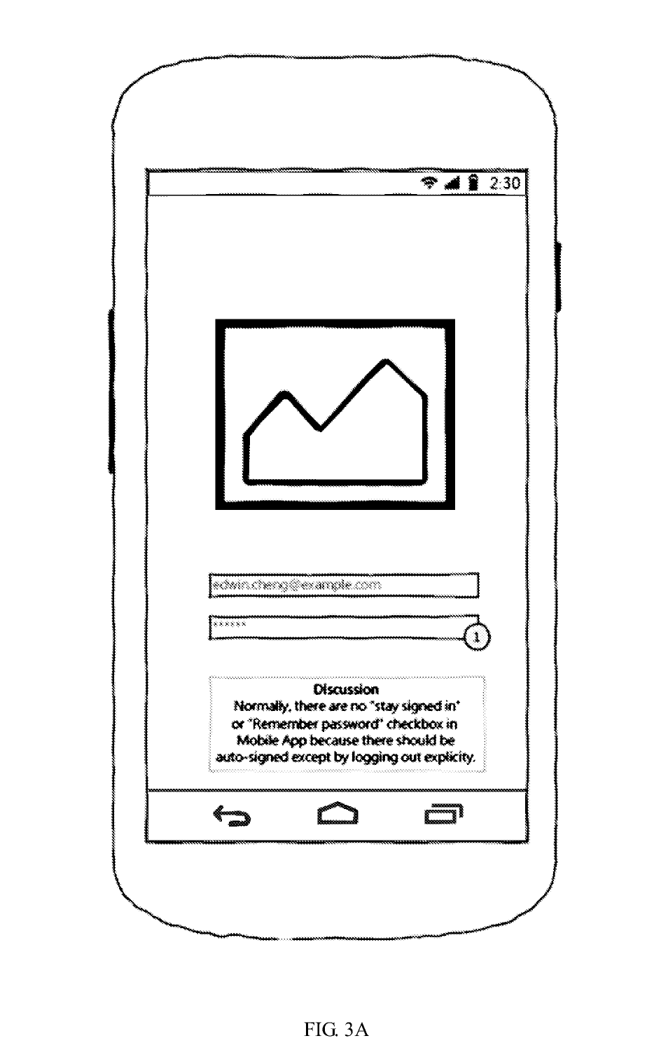

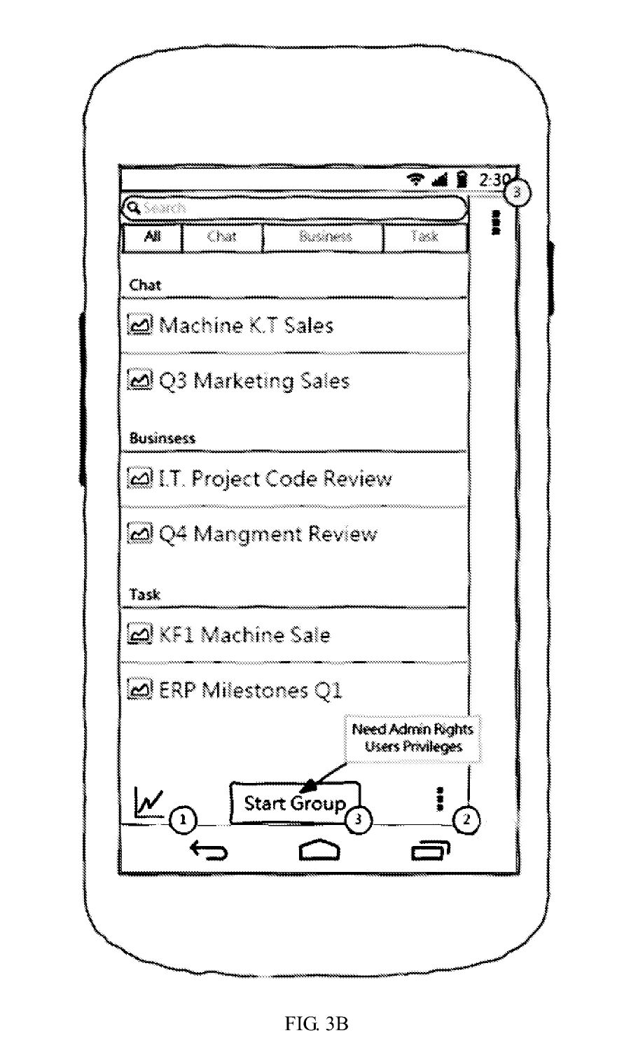

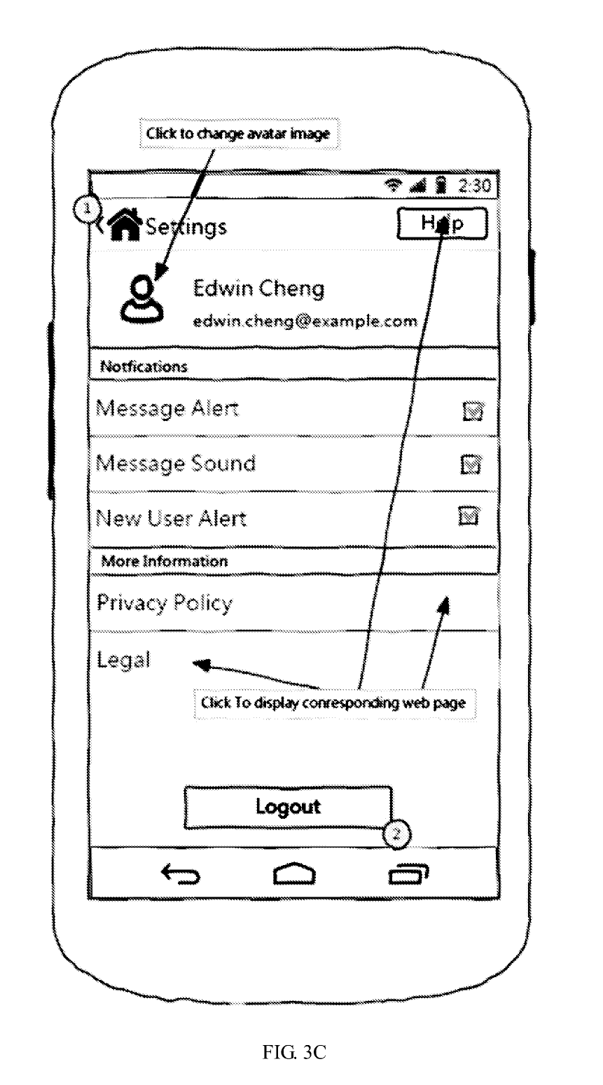

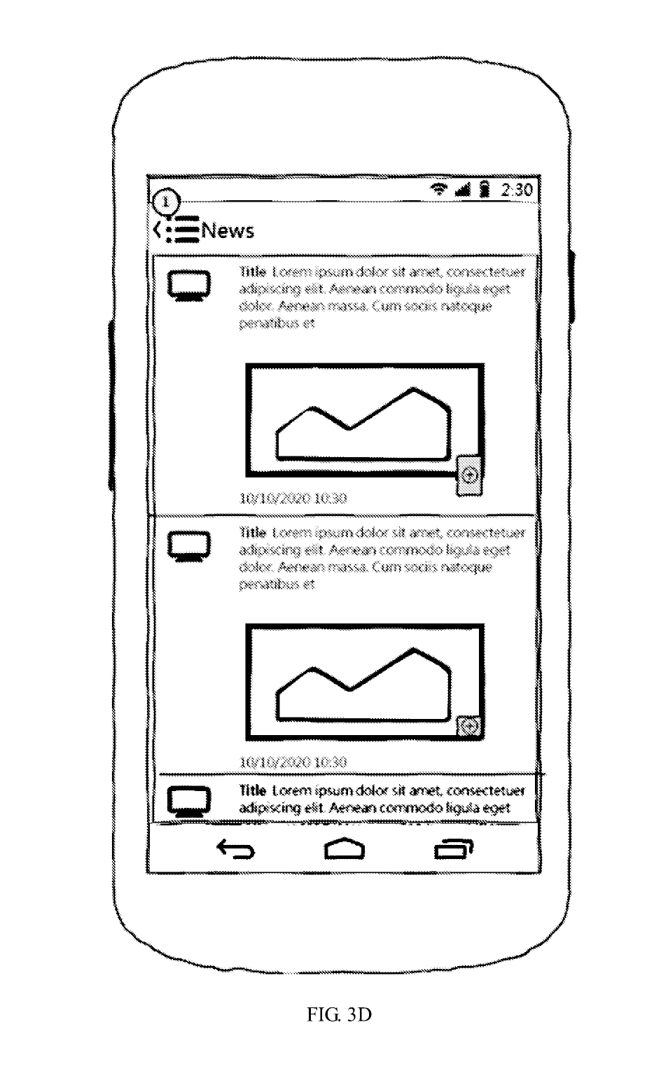

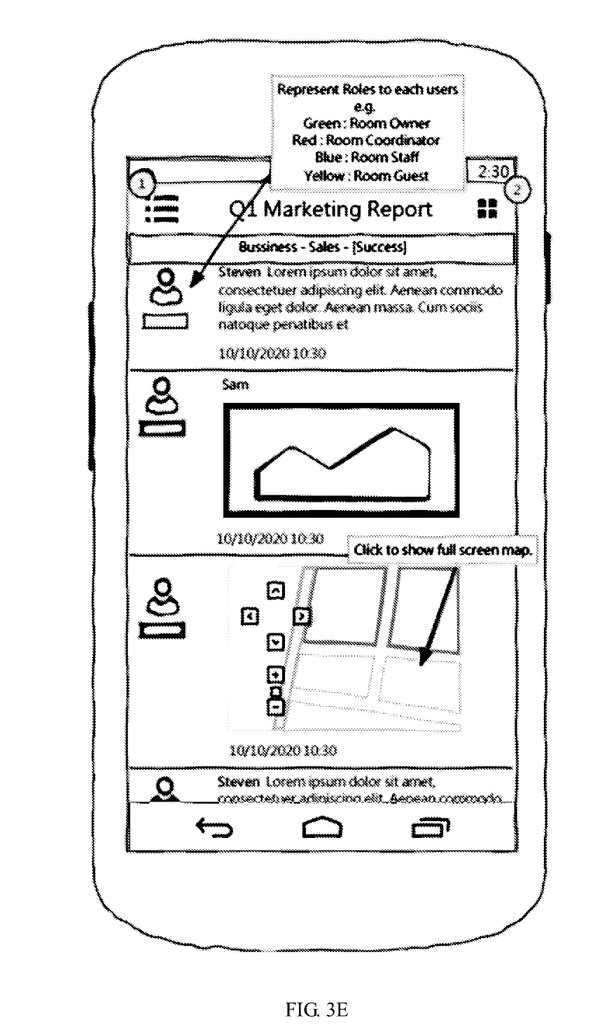

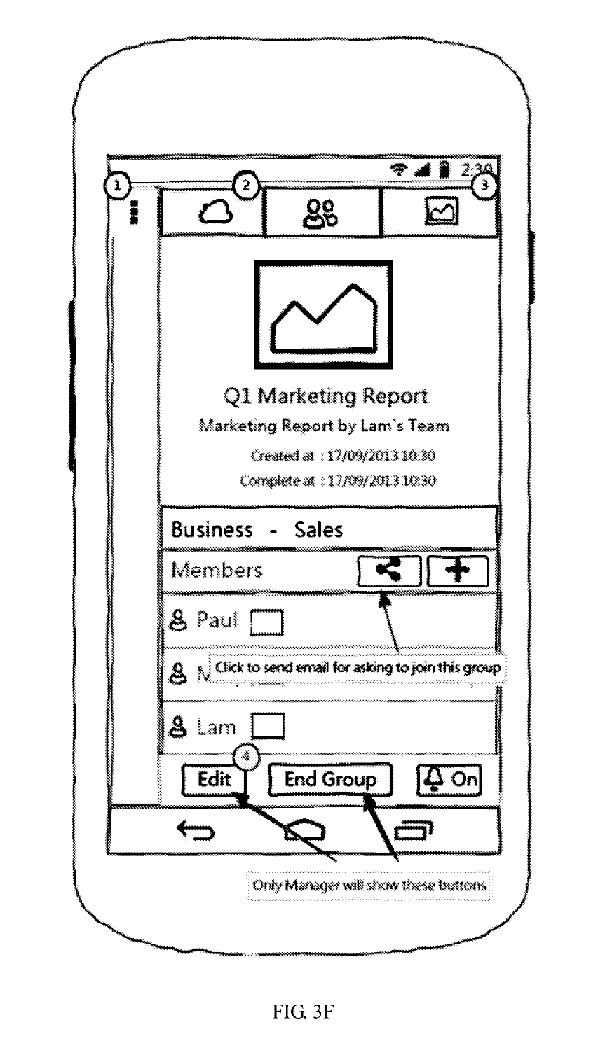

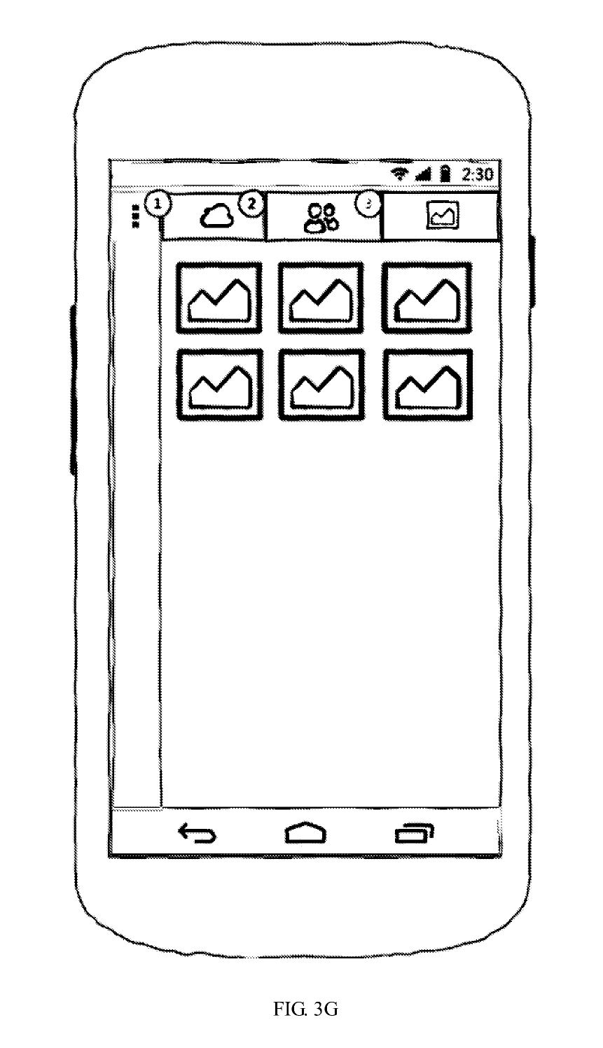

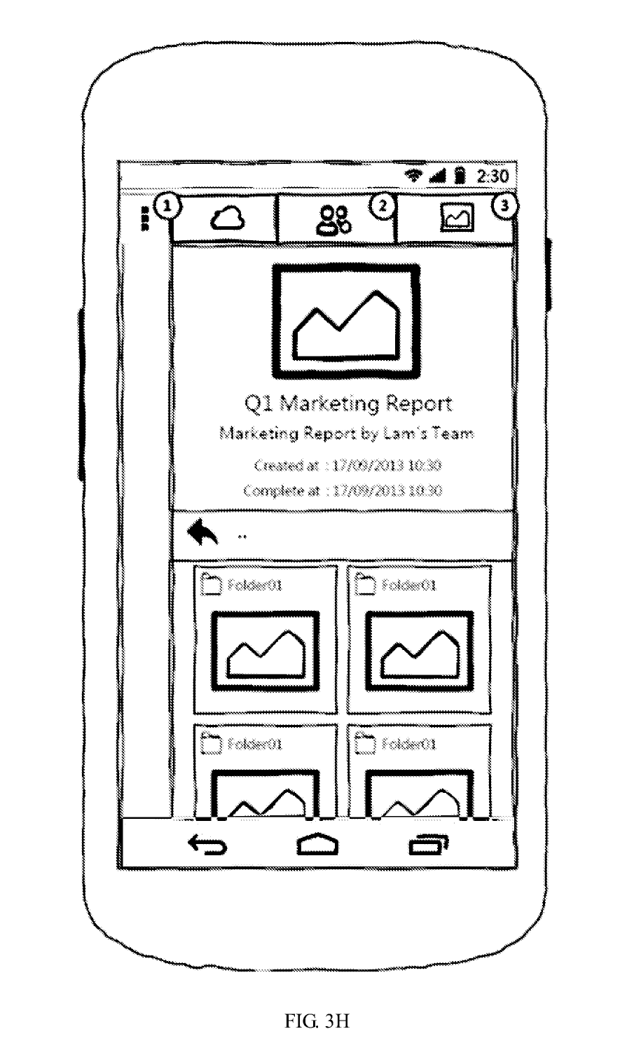

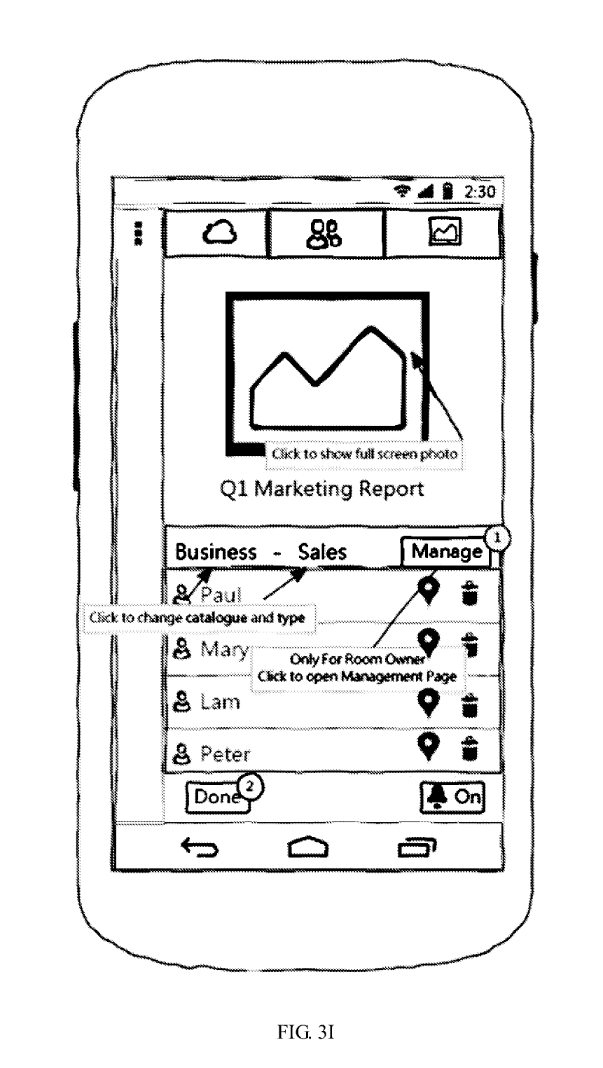

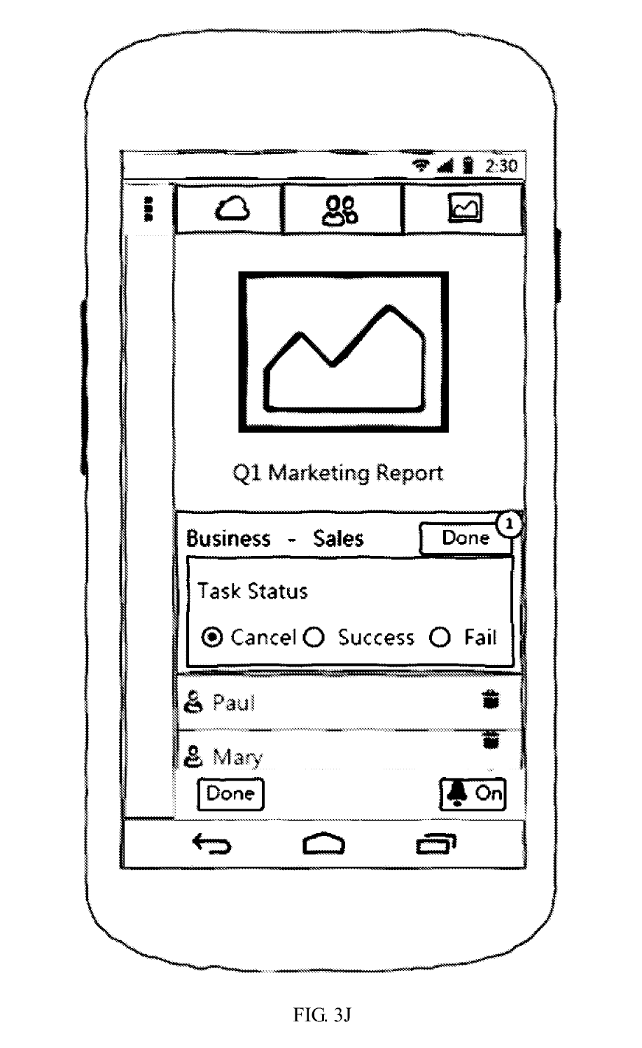

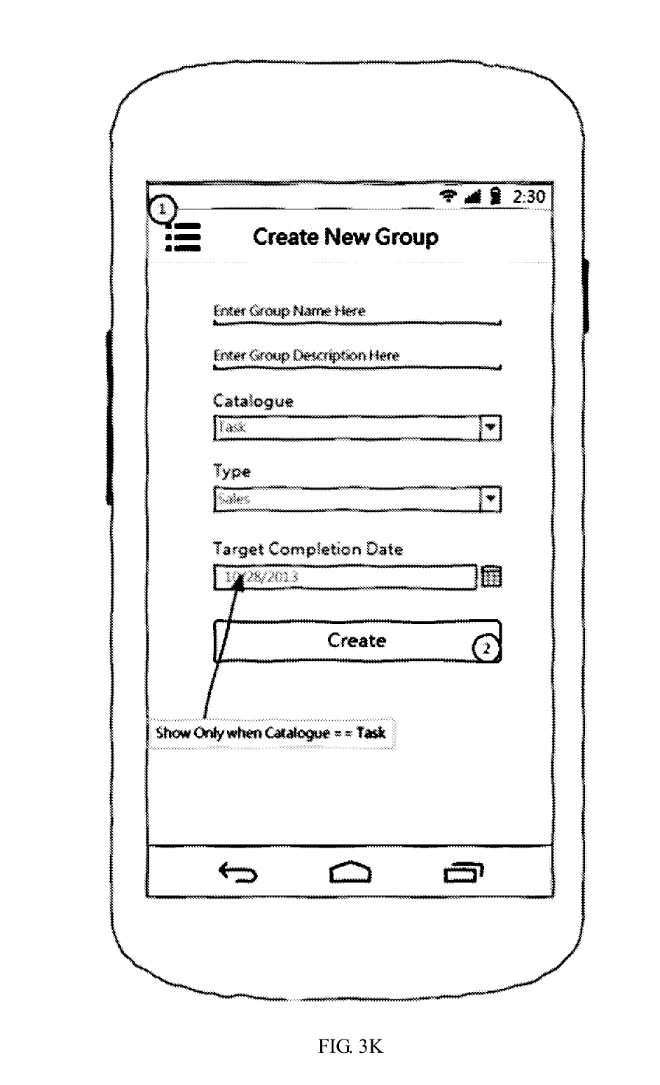

FIG. 1 is a partial logical diagram of embodiment of a B2C platform implementation system according to the present invention. The B2C platform implementation system comprises: a SQL database, a database management system, a Web server, an application server and a plurality of clients. Moreover, each client is equipped with an application which can be called as Bchat. The SQL database is used for storing the setup information of applications and CRM (Customer Relationship Management)/ERP (Enterprise Resource Planning) data. The database management system is used for regularly acquiring primary data from the SQL database, and analyzing the acquired data to generate a chart form marketing report. With reference to FIGS. 2A-2D, the marketing report at least comprises the several types as follows: sales, purchasing, production, account receivable, account payable, ledger, financial report, and human resources. The Web server is used for managing interfaces, user login authority and business report classification, and pushing business news and marketing report to a server. The application server is used for providing transmission of instant text information among a plurality of clients, and pushing the business news and marketing report to the plurality of clients. Moreover, the application server can also push calendar/task/news release/position information of other clients to the plurality of clients. With reference to the client interface as shown in FIGS. 3A-3K, the clients are used for business communications and displaying the business news and marketing report. Preferably, the application server enables transmission of instant text information among the plurality of clients through a chat room.

The present invention also constructs a B2C platform implementation method. The B2C platform implementation method comprises user login step, report viewing report, user group creation step, user group joining step, user group ending step, session text sharing step, news information release step and GPS positioning step. The several steps are described in details hereinafter.

When a user logs in, the user firstly inputs user login request information (including user name and password) on a login interface of the Bchat application on the client as shown in FIG. 3A. Preferably, automatic login can be set. The client sends the user login request information to a Web server. The Web server pushes login verification information to a SQL database according to the user login request information. If the login verification information is verified by the SQL database, then the Web server sends login confirmation information to the client. The client sends group update information and session information to the Web server.

After the user logs in, a main interface of the Bchat application as shown in FIG. 3B can be seen. The interface comprises several catalogues, i.e. “ALL”, “Chat”, “Business”, “Task”. Moreover, the user can enter corresponding catalogue interfaces by clicking corresponding options. Moreover, the user enters the interface as shown in FIG. 3C after clicking “Settings” option below the main interface. The user can conduct corresponding settings by clicking corresponding options, for example, setting avatar image, message alert, message sound, new user alert, and the like. Moreover, the user may also click “logout” to quit a use group.

When releasing news information, the Web browser sends news addition information to the Web server. The Web server sends news verification information to the SQL database according to the received news addition information. If the news addition information is verified by the SQL database, then the Web server broadcasts news update information to other clients. In this way, the user can view the news information released on the interface of the Bchat application on the client, as shown in FIG. 3D.

When the user views a report, the client sends report request information to the Web server. A database management system processes primary data acquired regularly from the SQL database according to the report request information received by the Web server to generate a marketing report, and pushes the generated business report to the Web server. The Web server then pushes the marketing report to an application server, and the application server finally pushes the business report to the client. In this way, the user can view the marketing report on the interface of the Bchat application on the client, as shown in FIG. 3F, wherein the marketing report is of a chart form.

When creating a user group, the client sends user group creation request information to the Web server, as shown in FIG. 3K. The user inputs the user group creation request information on the interface of the Bchat application of the client, for example, comprising: user group name, user group description, catalogue, type, target ending time (when the catalogue is task). The Web server sends user group creation verification information to the SQL database according to the user group creation request information. If the user group creation verification information is verified by the SQL database, then the Web server sends user group creation confirmation information to the client. Meanwhile, the Web server broadcasts user group update information to other clients. In this way, the user can view the updated user group information on the interface of the Bchat application of the client.

After one new user group is created, other users can join the user group. When one existing user group needs to be added, the client sends user group jointing request information to the Web server. The Web server sends user group joining verification information to the SQL database according to the user group joining request information. If the user group joining verification information is verified by the SQL database, then the Web server sends user group joining confirmation information to the client. Meanwhile, the Web server broadcasts user group update information to other clients.

After a plurality of users join the user group, the user group comprises a plurality of members, as shown in FIGS. 3E and 3F, wherein each user of the user group has an identity tag, for example, different identities are represented by following colors. Green represents chat room owner, red represents chat room coordinator, blue represents chat room staff, and yellow represents chat room guest. Moreover, FIG. 3G shows user group menu photo.

When the user is the chat room owner, the user can also edit the user group, for example, the user can click “Edit” on the interface as shown in FIG. 3F to enter the interface as shown in FIG. 3I, for example, to change the catalogue and type of the marketing report, view the full screen display of the marketing report, and the like. Then, the user may also click “Manage” on the interface as shown in FIG. 3I to enter the interface as shown in FIG. 3J, and can set task states in the interface.

When the user group needs to be completed, the client sends user group ending request information to the Web server, as shown in FIG. 3F. The user clicks “End Group” on the interface of the Bchat application of the client. The Web server sends user group ending verification information to the SQL database according to the user group ending request information. If the user group ending verification information is verified by the SQL database, then the Web server sends user group ending confirmation information to the client. Meanwhile, the Web server broadcasts user group update information to other clients.

When communications between a plurality of users is required, the client sends session text information to the Web server. The Web server sends session text verification information to the SQL database according to the received session text information. If the session text verification information is verified by the SQL database, then the Web server sends session text sending confirmation information to the client. Meanwhile, the Web server broadcasts session text sending update information to other clients.

When GPS positioning is required, the client acquires current position information and sends the position information to the Web server. The Web server sends position sending verification information to the SQL database according to the received position information. If the position sending verification information is verified by the SQL database, then the Web server sends position sending confirmation information to the client. Meanwhile, the Web server broadcasts position sending update information to other clients, as shown in FIG. 1, one user broadcasts the current position thereof to other members in the chat room.

The client transmits the session text information or position information to other clients through GCM, for example, FIG. 3G shows user group menu cloud.

The above descriptions are merely preferred embodiments of the present invention, but are not intended to limit the present invention. For those skilled in the art, the present invention may have various alternations and changes. Any modification, equivalent replacement, improvement and the like, made within the spirit and principle of the present invention, shall all fall within the scope of the claims of the present invention.

1. A B2C platform implementation system comprising:
a SQL database, used for storing setup information of applications and CRM/ERP data;
a database management system, used for regularly acquiring primary data from the SQL database, and analyzing the acquired data to generate a chart form marketing report;
a Web server, used for managing interfaces, user login authority and marketing report classification, and pushing business news and marketing report to a server;
an application server, used for providing transmission of instant text information among a plurality of clients, and pushing the business news and marketing report to the plurality of clients; and
the plurality of clients equipped with an application, used for business communications and displaying the business news and marketing report.

2. The B2C platform implementation system according to claim 1, wherein the application server enables transmission of instant text information among the plurality of clients through a chat room.

3. The B2C platform implementation system according to claim 1, wherein the marketing report at least comprises the several types as follows: sales, purchasing, production, account receivable, account payable, ledger, financial report, and human resources.

4. The B2C platform implementation system according to claim 1, wherein the application server further pushes calendar/task/news release/position information of other clients to the plurality of clients.

5. The B2C platform implementation system according to claim 1, wherein the application server, on the basis of a user subscription request, pushes the marketing report to the plurality of clients in a specific time or in response to a specific event.

6. A B2C platform implementation method comprising:
user login step: sending, by a client, user login request information to a Web server, and pushing by the Web server, login verification information to a SQL database according to the user login request information; if the login verification information is verified by the SQL database, then sending, by the Web server, login confirmation information to the client, and sending, by the client, group update information and session information to the Web server; and
report viewing report: sending, by the client, report request information to the Web server, and processing, by a database management system, primary data acquired regularly from the SQL database according to the report request information received by the Web server to generate a marketing report, and pushing the generated marketing report to the Web server; then pushing, by the Web server, the marketing report to an application server, and finally pushing, by the application server, the marketing report to the client.

7. The B2C platform implementation method according to claim 6, further comprising:
user group creation step: sending, by the client, user group creation request information to the Web server, and sending, by the Web server, user group creation verification information to the SQL database according to the user group creation request information; if the user group creation verification information is verified by the SQL database, then sending, by the Web server, user group creation confirmation information to the client; meanwhile, broadcasting, by the Web server, user group update information to other clients.

8. The B2C platform implementation method according to claim 6, further comprising:
user group joining step: sending, by the client, user group jointing request information to the Web server, and sending, by the Web server, user group joining verification information to the SQL database according to the user group joining request information; if the user group joining verification information is verified by the SQL database, then sending, by the Web server, user group joining confirmation information to the client; meanwhile, broadcasting, by the Web server, user group update information to other clients.

9. The B2C platform implementation method according to claim 7, further comprising:
user group ending step: sending, by the client, user group completion request information to the Web server, and sending, by the Web server, user group ending verification information to the SQL database according to the user group ending request information; if the user group ending verification information is verified by the SQL database, then sending, by the Web server, user group ending confirmation information to the client; meanwhile, broadcasting, by the Web server, user group update information to other clients.

10. The B2C platform implementation method according to claim 8, further comprising:
session text sharing step: sending, by the client, session text information to the Web server, and sending, by the Web server, session text verification information to the SQL database according to the received session text information; if the session text verification information is verified by the SQL database, then sending, by the Web server, session text sending confirmation information to the client; meanwhile, broadcasting, by the Web server, session text sending update information to other clients.

11. The B2C platform implementation method according to claim 9, further comprising:
news information release step: sending, by a Web browser, news addition information to the Web server, and sending, by the Web server, news verification information to the SQL database according to the received news addition information; if the news addition information is verified by the SQL database, then broadcasting, by the Web server, news update information to other clients.

12. The B2C platform implementation method according to claim 10, further comprising:
GPS positioning step: acquiring, by the client, current position information and sending the position information to the Web server, and sending, by the Web server, position sending verification information to the SQL database according to the received position information; if the position sending verification information is verified by the SQL database, then sending, by the Web server, position sending confirmation information to the client; meanwhile, broadcasting, by the Web server, position sending update information to other clients.

13. The B2C platform implementation method according to claim 11, comprising the step of transmitting, by the client, the session text information or position information to other clients through GCM.
